(19) United States
(12) Patent Application Publication
(10) Pub. No.: US 2010/0127207 A1
(43) Pub. Date: May 27, 2010

(54) Magnetic receptive extruded films

(76) Inventor: Dayton Joseph Deetz, Mendon, MA (US)

Correspondence Address: Dayton J. Deetz, 73 Washington Street, Mendon, MA, 01756, US

(21) Appl. No.: 12/590,293

(22) Filed: Nov. 5, 2009

Related U.S. Application Data
(60) Provisional application No. 61/198,524, filed on Nov. 6, 2008.

(51) Int. Cl. H01F 1/00

(52) U.S. Cl. 252/62.51 R; 428/500

(57) ABSTRACT

The practical application of incorporating magnetic receptive particles embodied in the formulation of an extruded film will produce a magnetic receptive film with properties that will adhere to magnets. Furthermore, incorporating the technique of co-extrusion, one can produce a print media with a magnetic receptive core while maintaining an un-altered first and third layers.

### TECHNICAL FIELD OF THE INVENTION

This invention incorporates magnetic receptive media combined into the formulation of a standard extruded film. Products now available to the print market combine a commercially extruded film and a magnetic receptive coating applied after the extrusion process. This produces a one-sided printing film that will adhere to magnets. This new invention is showing the advantages of the incorporation of magnetic receptive media in the formulation of the extrusion process, which can yield a print media that has magnetic receptive properties and maintains a print surface on both sides.

In many disclosed processes, there has been numerous additions of both organic and inorganic media included in the master batching of polymers for extruded films. These have many commercial uses such as light blocking, increasing opacity and changing the post processing characteristics along with multiple other advantages. These additive approaches have been employed in the full range of media such as Polypropylene, Polyester, Polyethylene and many other type and variations of synthetic films.

### BACKGROUND OF THE INVENTION

We have developed numerous magnetic receptive products from paints to papers and coated films. This product line allows us to produce a magnetic receptive print media in one process instead of first extruding the film and then coating the film. Retail graphics are always changing and the need for a two-sided product is very real. Having the ability to reduce waste, lower shipping costs and mediate the need for installation is a game changer in the industry. In previous disclosed inventions U.S. Pat. No. 5,945,205, the use of fillers in the core layer (1^{st}layer) is useful for a light absorbing purpose to prevent spoilage of packaged food from UV degradation. In their process, they employ lamellar pigments such as graphite to enhance the voiding process and create an ultraviolet light block. This pigment is typically present in a 0.5% to 5% weight ratio. In our invention, we have the employment of magnetite powder or other ferromagnetic particles in the size ratio between 0.01 μ to 30 μ at a weight ratio between 15% and 70% by weight. This is a considerably higher load than practiced in the industry. U.S. Pat. No. 4,345,005, discloses the use of additives to enhance adhesion of metallized coatings. Electron beam curing in a reactive setting, cures these coatings. This process is incapable of adding material that a magnet will adhere to.

U.S. Pat. No. 4,117,193, teaches, that the inclusion of low-crystalline resin of an ethylene-butene copolymer and a polyolefin resin with a lubricant and an anti-blocking agent onto the surface produces a film that demonstrates low static properties and will aid in the prevention of blocking.

### SUMMARY OF THE INVENTION

This invention is based on the incorporation of magnetic receptive media in a conventional extrusion process coupled with the ability to co-extrude a top and bottom layer suitable to accept printing. This approach has not been taken in the extrusion process, using higher than what is perceived as normal loads of filler in the polymer to produce a film with strong magnetic properties suitable to adhere to magnets and multilayer one on top of the other. This invention will reduce waste in the industry and present a more environmentally responsible option. The used product can be shipped back to the factory and master batched into the core layer. This is possible due to the white printable outer layers that conceal the magnetic receptive core.

### EXAMPLE

The following example is presented to further illustrate and explain the present invention and should not be taken as limiting in any regard.

### Example 1

A mixture of polypropylene resins compounded with magnetic receptive particles in a 25% load by weight formulated to be compatible with extruding films is co-extruded with a top and bottom layer sandwiching the magnetic receptive layer in between.

It is important to adjust the flow temperature between the first layer and subsequent outer layers. Having the high load of magnetite or other ferromagnetic media, will act as a heat sink and cause a slower cooling. The addition of high loads of clay or calcium carbonate in the outer layers can help compensate the embodiment difference. This will also add to the print receptiveness of the surface layer. The co-extruded web can be followed by stepwise orientation, both in the longitudinal and transverse direction. Micro-voiding and cavitation techniques can be applied to this invention as process employment. The preferred melting points of the polymer are between 400° F. and 600° F.

### BRIEF DESCRIPTION OF THE DRAWINGS

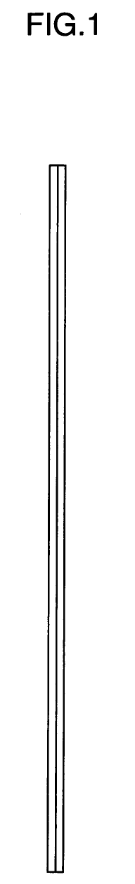

This invention is illustrated in the drawings in FIGS. 1 through 3 they are all cross-sections of the extruded film.

### DETAILED DESCRIPTION OF THE DRAWINGS

FIG. 1 depicts a two-layered co-extruded film embodying ferromagnetic particles in layer 2 while maintaining first layer (1) with the absence of any ferromagnetic particles on the outside surface.

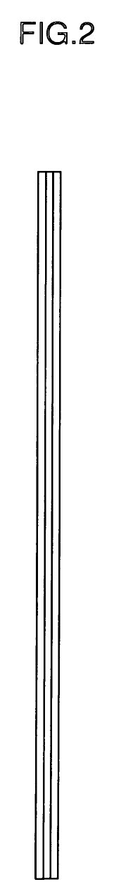

FIG. 2 depicts a three layered co-extruded film embodying ferromagnetic particles in layer 2 while maintaining first (1) and third (3) layer with the absence of any ferromagnetic particles on the outside surfaces.

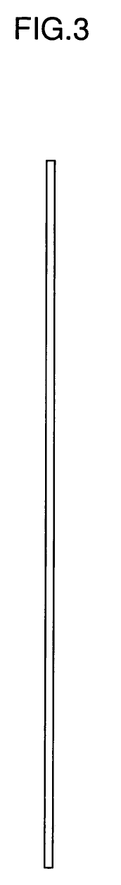

FIG. 3 depicts a single layered extruded film embodying ferromagnetic particles.

1. A film structure comprising a magnetic receptive core layer with one or more outer layers suitable to accept printing.

2. An extruded film structure comprising a magnetic receptive core layer with one or more outer layers suitable to accept printing.

3. A co-extruded film structure comprising a magnetic receptive core layer with one or more outer layers suitable to accept printing.

4. A cast film structure comprising a magnetic receptive core layer with one or more outer layers suitable to accept printing.

5. A film embodying ferromagnetic material with one or more outer layers biaxially-oriented to improve outer layer opacity.

6. A film embodying ferromagnetic media suitable for adhering to magnets.
